(19) United States
(12) Patent Application Publication
(10) Pub. No.: US 2008/0273746 A1
(43) Pub. Date: Nov. 6, 2008

(54) Image Processing Apparatus

(75) Inventor: Katsushi MINAMINO, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 12/111,848

(22) Filed: Apr. 29, 2008

(30) Foreign Application Priority Data
May 1, 2007 (JP) 2007-120493

(51) Int. Cl. G06K 9/00

(52) U.S. Cl. 382/100

(57) ABSTRACT

An image processing apparatus which is able to make a copy whose character information is clearly readable for a predetermined document registered as a special document is provided. A fixed-format document including the character information written in a predetermined format is determined as the special document and the special document identification information for identifying the special document is stored. An original document determining unit compares document color distribution information (color distribution information relating to a sample area of a special document) retained as the special document identification information with original document color distribution information (color distribution information of an area corresponding to the sample area of the special document) and, when the both of them match, the original document is determined to be a special original document. When the original document corresponds to the special document, image data acquired by reading out the original document is converted into monochrome image data and is recorded on a recording sheet.

### CROSS-REFERENCE TO RELATED APPLICATIONS

This application claims priority under 35 U.S.C. 119 to Japanese Patent Application No. 2007-120493, filed on May 1, 2007, which application is hereby incorporated by reference in its entirety.

### BACKGROUND OF THE INVENTION

1. Field of the Invention

The present invention relates to an image processing apparatus having a function to carry out adequate processing by switching the processing mode according to the type of an original document

2. Description of the Related Art

In image processing apparatuses such as facsimile devices, copying machines and printers, which scan original documents to acquire and reproduce image data on a medium such as paper, the ability to finely reproduce colors or the like of the original document is increasing in association with the progress of image processing technology. As an adverse effect, copies of documents on which confidential data are written such as bills and certificates can be disguised as original copies.

In order to prevent acquisition of copies for such ill-intended object, there is a technology to add a tint block on a sheet of certificate or the like. When a certificate added with a tint block is copied, a predetermined latent image appears on the copy, so that a copy that is completely the same document as the original document cannot be obtained. Accordingly, a preventive effect of the ill-intentioned copy is achieved. For example, JP-A-2006-295857 discloses a technology for apparently developing a latent image of a tint block.

As described above, when a tint block is added, the same document as an original document cannot be obtained, and a copy is thereby prevented from being disguised as the original copy. However, a copy is not necessarily made for the purpose of disguise as the original copy. For example, in the case of bills or certificates, there is a case in which a copy is made for the purpose of acquiring character information written in a predetermined format.

In other words, among original documents there exist special documents of which copies are required for special purposes (that is, a purpose to obtain clear character information in the document) in addition to normal documents, a copy of which is taken by a user for the purpose of obtaining the same copy.

However, according to the conventional art, the normal process that is carried out for making a same copy of an original document is also carried out in the case of the special documents as described above. Consequently, when a tint block is added to an original document, a latent image explicitly appears on the copy, so that character information on the original document cannot be read easily from the copy.

### SUMMARY OF THE INVENTION

In order to overcome the problems described above, the invention provides an image processing apparatus that is able to make copies of special documents to be taken by users for a special purpose (that is, a purpose of obtaining copies in which character information is clearly readable).

In other words, the invention provides an image processing apparatus that is able to make copies of predetermined documents that are registered as special documents, in which character information is clearly readable.

An image processing apparatus according to the present invention includes a special document identification information storage unit that stores identification information of color image element for identifying a fixed-format document on which character information is written in a predetermined format as a special document, a determining unit for determining whether or not an original document corresponds to the special document on the basis of the identification information, an image data converting unit that converts the image data acquired by scanning the original document into monochrome image data when the original document corresponds to the special document, and an output unit that outputs the monochrome image data.

In one embodiment, the identification information is color distribution information of a predetermined sample area in the fixed-format document.

In one embodiment, the image processing apparatus includes a special document identification information acquiring unit that scans the fixed-format document to be registered as the special document and acquires the color distribution information in the predetermined sample area in the fixed-format document.

In one embodiment, the image processing apparatus includes a sample area determining unit that determines the sample area in the fixed-format document to be employed by the special document identification information acquiring unit according to an instruction from a user.

In one embodiment, the image processing apparatus includes a color skipping unit that converts a predetermined color that is included in the image data acquired by scanning the original document into a color-not-to-be-recorded when the original document corresponds to the special document.

In one embodiment, the color skipping unit includes a color-to-be-skipped determining unit that determines a color that is to be converted into the color-not-to-be recorded according to an instruction from the user.

In one embodiment, the color-to-be-skipped determining unit includes a color-to-be-skipped area specification accepting unit that accepts a specification of the color skipping area in an area within the fixed-format document to be registered as the special document from the user; and a color information acquiring unit that acquires color information of the color skipping area in the fixed-format document by scanning the fixed-format document and determines the acquired color information as color information of a color to be converted into the color-not-to-be-recorded.

In one embodiment, the color-to-be-skipped determining unit includes a color-to-be-skipped area specification accepting unit that accepts a specification of the color skipping area in an area within the fixed-format document to be registered as the special document from the user; and the color skipping unit includes the color information acquiring unit that scans the document when the original document corresponds to the special document to acquire the color information of the color skipping area on the original document as the color information of the color to be converted into the color-not-to-be-recorded.

In one embodiment, the predetermined color is the color of a tint block.

In one embodiment, the image processing apparatus includes a black correction unit that converts the predetermined color included in the image data acquired by scanning the original document into black when the original document corresponds to the special document.

According to the present invention, image data acquired by scanning an original document that corresponds to a document registered as a special document is converted into monochrome image data and is outputted, so that a copy in which character information is clearly readable is obtained. In other words, a monochrome portion and a colored portion of the original document are both viewed generally by a human being in terms of visual stimulation, but the image element (such as the tint block) that characterizes the original document to be the special document is displayed in a color having a significantly low density (high brightness) so as not to impair the information display of the character portion. In the processing of converting into the monochrome image, only the densities of the respective portions of the original document are reflected and information such as the hue difference is eliminated. Therefore, the color portion having a low density (that is, having a light shade) is erased or restrained when the image of the original document as the special document is converted into the monochrome image. The character portion of the original document is generated to have a significantly high density irrespective of whether it is expressed in monochrome or in color. Consequently, an image in which the character portion is expressed relatively clearly is obtained by the conversion into a monochrome image.

In particular, the unit that scans a fixed-format document to be registered as a special document and acquires the identification information of the fixed-format document is provided, and hence the user is able to register the desired document as the special document.

In particular, the sample area to be specified in the fixed-format document is determined according to an instruction from the user. Therefore, the user is able to specify the desired area of the format document to be registered as the special document as the sample area.

In particular, when the original document corresponds to the special document, the predetermined color included in the image data acquired by scanning the original document is converted into the color-not-to-be-recorded. Therefore, the predetermined color is not reproduced when being copied. Accordingly, the character information in the copy is stood out.

In particular, since the color to be converted into the color-not-to-be-recorded is determined according to the instruction from the user, the user is able to specify a given color included in the fixed-format document to be registered as the special document as a color-not-to-be-reproduced in the copy.

In particular, since the color information of the color-to-be-skipped in the original document is employed as the color information of the color to be converted into the color-not-to-be-recorded, even when the density fluctuation exists among original documents, an accurate color which the user desires is specified as the color-not-to-be-reproduced in the copy.

In particular, since the color to be converted into the color-not-to-be-recorded is the color of the tint block, the tint block is not reproduced in the copy. In other words, the tint block is not elicited in the copy. Therefore, even when the tint block is added to the original document, a copy in which character information is clearly readable is obtained.

In particular, when the original document corresponds to the special document, the predetermined color included in the image data acquired by scanning the original document is converted into black color, so that black color is emphasized in the copy. Accordingly, character information in the copies is stood out.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram of a configuration of a digital multifunction peripheral according to an embodiment of the present invention.

FIG. 2 is a block diagram of a functional configuration relating to a process to be applied to a special original document.

FIG. 3 is a drawing illustrating a fixed-format document to be registered as a special document.

FIGS. 4A and 4B are drawings illustrating an example of the special original document and a copy thereof.

FIGS. 5A and 5B are examples of conversion graphs relating to Y-component correction.

FIG. 6 is a flowchart of the process carried out when registration of special document information from a user is accepted.

FIG. 7 is a rough flowchart of an image forming process carried out in the digital multifunction peripheral.

FIG. 8 is a flowchart of a determination process of whether an original document corresponds to the special document or not.

FIG. 9 is a flowchart of a process to be applied to the special original document.

FIG. 10 is a block diagram of a functional configuration relating to the process to be applied to the special original document.

FIG. 11 is a flowchart of a determination process of whether the document is the special original document or not.

### DETAILED DESCRIPTION OF PREFERRED EMBODIMENTS

### 1. Configuration

### 1-1. Digital Multifunction Peripheral

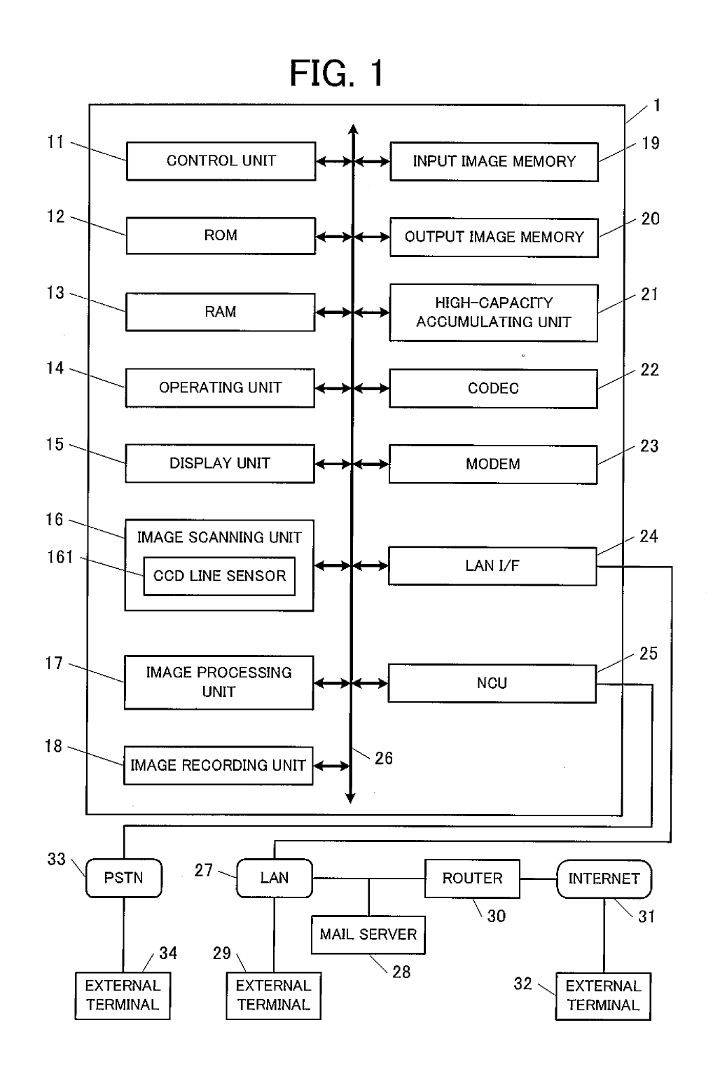

Referring now to FIG. 1, a digital multifunction peripheral 1 that integrates a function of an image processing apparatus corresponding to a first embodiment of the present invention is described.

The digital multifunction peripheral (MFP) 1 has a plurality of functions such as facsimile (FAX), copying, scanning and printing functions. The digital multifunction peripheral 1 includes a control unit 11, a Read Only Memory (ROM) 12, a Random Access Memory (RAM) 13, an operating unit 14, a display unit 15, an image processing unit 17, an image scanning unit 16, an image recording unit 18, an input image memory 19, an output image memory 20, a high-capacity accumulating unit 21 and functional communication units 22-25 electrically connected via a bus line 26.

The control unit 11 is composed of a Central Processing Unit (CPU). The control unit 11 controls the hardware described above individually on the basis of a program stored in the ROM 12, and realizes a function of the digital multifunction peripheral 1.

The ROM 12 is a read only storage device in which programs or data required for controlling the digital multifunction peripheral 1 are stored in advance.

The RAM 13 is a readable and writable storage device and stores various data to be accumulated temporarily such as image data, a FAX number or an e-mail address, or data generated when the control unit 11 carries out arithmetic processing. The RAM 13 is composed of a Static Random Access Memory (SRAM) or the like.

The operating unit 14 includes various keys such as character keys, ten-keys and function keys, and accepts a user operation such as entry of commands or text data. The user operation accepted by the operating unit 14 is entered into the control unit 11 as a signal. The control unit 11 controls operations of the individual units on the basis of the user operation.

The display unit 15 displays the state of operation of the digital multifunction peripheral 1 or the image data, and is composed of a display device such as a liquid crystal display. The various keys provided on the operating unit 14 may be realized by a touch panel provided on the display screen of the display unit 15.

The image scanning unit 16 is a scanner that scans an image on an original document using a scanning element (CCD line sensor 161). The image data acquired by the image scanning unit 16 is compressed (into a JPEG format, for example) by CODEC 22 and is stored in the input image memory 19. The image scanning unit 16 may be a scanner of a type that scans the surface of the original document placed on a glass table by the scanning element to read the image (Flat Bed Scanner (FBS) type), and may be a scanner of a type that carries the document placed on a document table by an Auto Document Feeder (ADF) and scans the surface of the carried original document using a stationary scanning element to read the image (ADF type). The ADF type scanner may be of a type that scans a moving original document with a stationary image scanning optical system (sheet through type), or may be of a type that scans a stationary original document with a moving image scanning optical system. When the latter type is employed, the image scanning unit 16 repeats a scanning procedure of carrying an original document to a glass table, keeping the document stationary on the glass table, scanning the stationary original document with the moving image scanning optical system, and discharging the original document after having completed the scanning.

The CCD line sensor 161 receives light guided from the image scanning optical system that scans the original document at a predetermined scanning speed (the relative speed of movement between the original document and the image scanning optical system) and repeats scanning at a constant cycle to generate image data expressed in a RGB color space, that is, image data having color component data of red (R), green (G) and blue (B) (RGB image data). The scanning speed of the image scanning optical system is set on the basis of the resolution of the image data generated by the CCD line sensor 161 (more specifically, the resolution in the secondary scanning direction). In other words, the higher the resolution in the secondary scanning direction is, the lower the scanning speed of the image scanning optical system to be set becomes, and the lower the resolution in the secondary scanning direction is, the higher the scanning speed of the image scanning optical system to be set becomes.

The image processing unit 17 is a processing unit that carries out various kinds of image processing for received image data or image data acquired from the image scanning unit 16. For example, the image processing unit 17 carries out image processing such as A/D conversion, various types of correction (for example, shading correction or gamma correction), color specification system conversion (for example, conversion from image data of an RGB color specification system to image data of a YCbCr color specification system by matrix conversion), color adjustment, and image composition. The image processing unit 17 may be realized as software by a program stored in the ROM 12.

The image recording unit 18 is a printer that records image data or the like stored in the output image memory 20 on a recording sheet. An electrophotographic type printer, for example, may be employed as the image recording unit 18.

The input image memory 19 is a storage device for temporarily storing image data received from external devices 29, 32, 34 through the local area network interface (LAN I/F 24) or the network control unit (NCU) 25, image data acquired by the image scanning unit 16, or image data processed by the image processing unit 17. The input image memory 19 is composed of readable and writable memory such as a Dynamic Random Access Memory (DRAM).

The output image memory 20 is a storage device for storing image data used for output. The term “output” used here includes, for example, print output by the image recording unit 18 and transmission to an external terminal connected via communication lines. The output image memory 20 is composed of a readable and writable memory such as the DRAM.

The high-capacity accumulating unit 21 is composed of a hard disk or the like. The high-capacity accumulating unit 21 accumulates image data processed by the image scanning unit 16.

The digital multifunction peripheral 1 also includes the CODEC 22 that codes and decodes the image data or the like corresponding to a plurality of protocols, the modem 23 that modulates and demodulates send/receive data, the LAN I/F 24 that corresponds to an interface with respect to a local area network (LAN) 27, and the NCU 25 that controls opening and closing of a telephone line electrically connected thereto as functional units relating to communication via the bus line 26.

Any one of formats such as Modified Huffman (MH), Modified Read (MR), Modified MR (MMR) and Joint Bi-level Image experts Group (JBIG) may be employed as coding carried out by the CODEC 22 when coding binary data. The CODEC 22 also codes multi-valued data. Coding of multi-valued data is carried out, for example, in JPEG format.

A communication environment of the digital multifunction peripheral 1 will now be described. The digital multifunction peripheral 1 is connected to the LAN 27. A mail server 28 and an external terminal 29 are connected to the LAN 27. The LAN 27 is connected to Internet 31 via a router 30 or the like. In this configuration, the digital multifunction peripheral 1 achieves e-mail communication with the external terminal 29 connected via the LAN 27 or the external terminal 32 connected via the Internet 31. Furthermore, the digital multifunction peripheral 1 is connected to a Public Switched Telephone Network (PSTN) 33 serving as a data communication network for an analogue line. Accordingly, the digital multifunction peripheral 1 is able to communicate with the external terminal 34 connected via the PSTN 33. The external terminals 29, 32 and 34 may be, for example, personal computers connected via a modem, devices equivalent to the digital multifunction peripheral 1, fixed telephone sets, mobile telephone sets, or facsimile-specific machines.

### 1-2. Configuration Relating to Processing of Special Original Document

The digital multifunction peripheral 1 includes a plurality of processing modes according to the type of original documents to be processed. In particular, in the case of an original document that corresponds to a document registered as a “special document” (hereinafter, referred to as a “special original document”), a process for the corresponding original document is carried out in a predetermined “special original document processing mode”.

The “special document” is a fixed-format document that is prepared by writing character information in a predetermined format and includes, for example, motor vehicle inspection certificates and resident's cards. These “special documents” are characterized in that character information (address, name, etc.) in an information body is displayed by monochrome characters, and authentication information such as a tint block in faint chromatic color is displayed as a background image in many cases to serve as an image element indicating that the document is the real one. The term “faint” in this specification means that the display density is lower (brightness is higher) than the information body to be displayed. An original document may also include a color picture other than a tint block, such as a driver's license. The color picture in this case functions as part of information to be displayed and hence is displayed at a density which is not low for securing sharpness. In other words, from the viewpoint of density, the following relations for authentication are established: (1) high density for character information, (2) middle density for photo information and (3) low density for image elements (such as a tint block). Among them, the image elements for authentication have a significantly large density difference in comparison with the relations (1) and (2), and hence the difference may be emphasized by image conversion such as isolation and erasing of these elements or suppression of only these elements. Therefore, the apparatus in the embodiment of the present invention employs this principle. In other words, the body portion of information such as character information is effectively extracted by a contrast emphasizing process such as lowering of the visibility of an image element that guarantees that a special document is the real one. In other words, the “special original document processing mode” is a processing mode not to generate a copy by reproducing the document faithfully, but to generate a copy in which the character information in the document is reproduced in an eye-friendly manner.

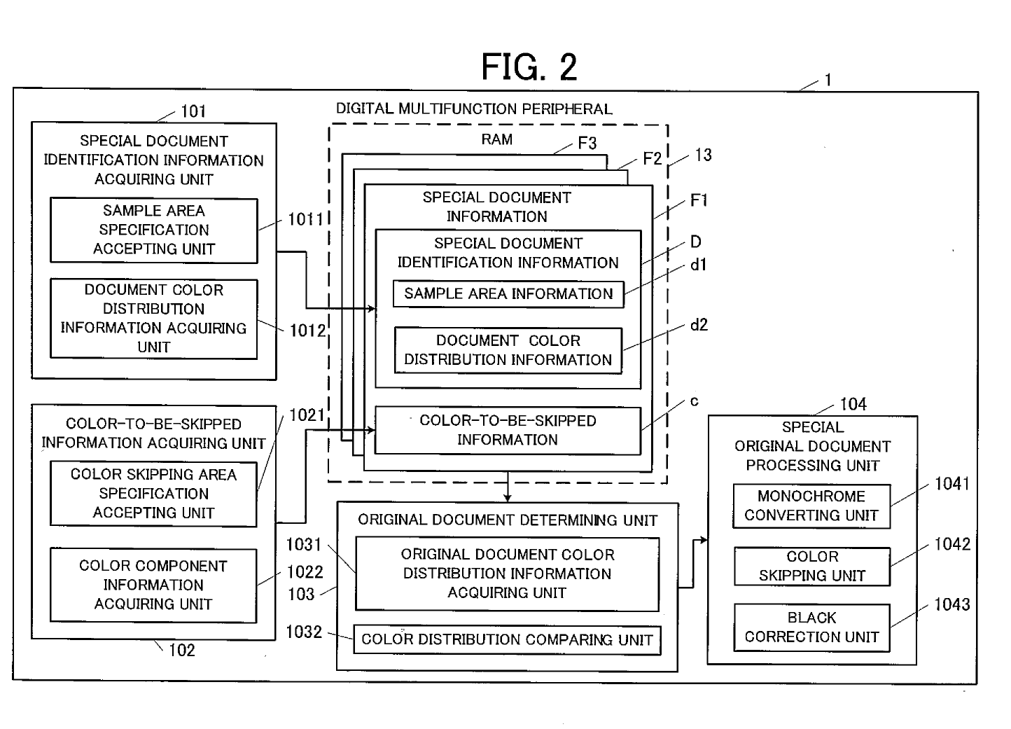

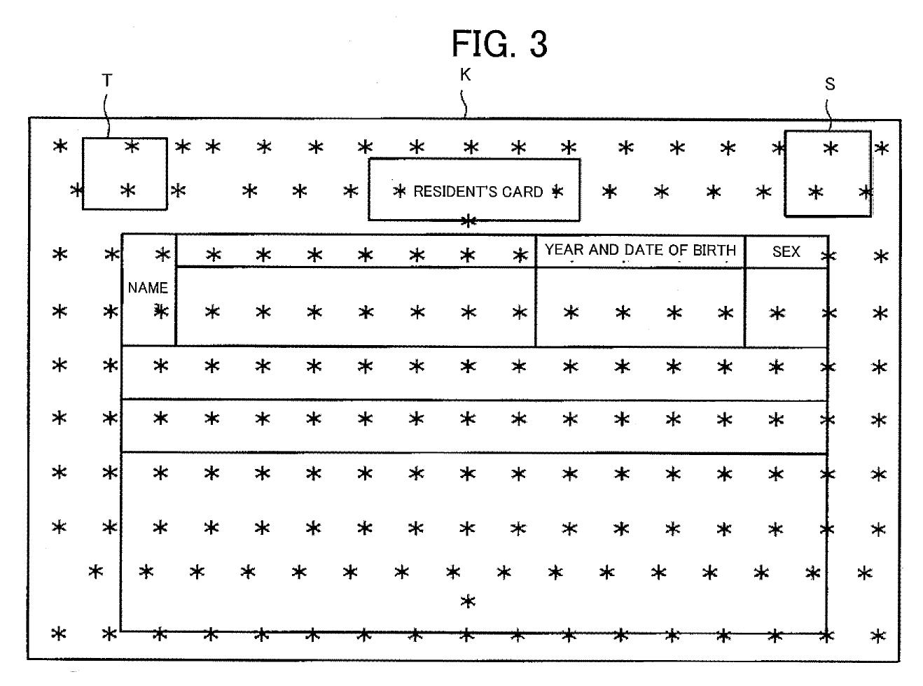

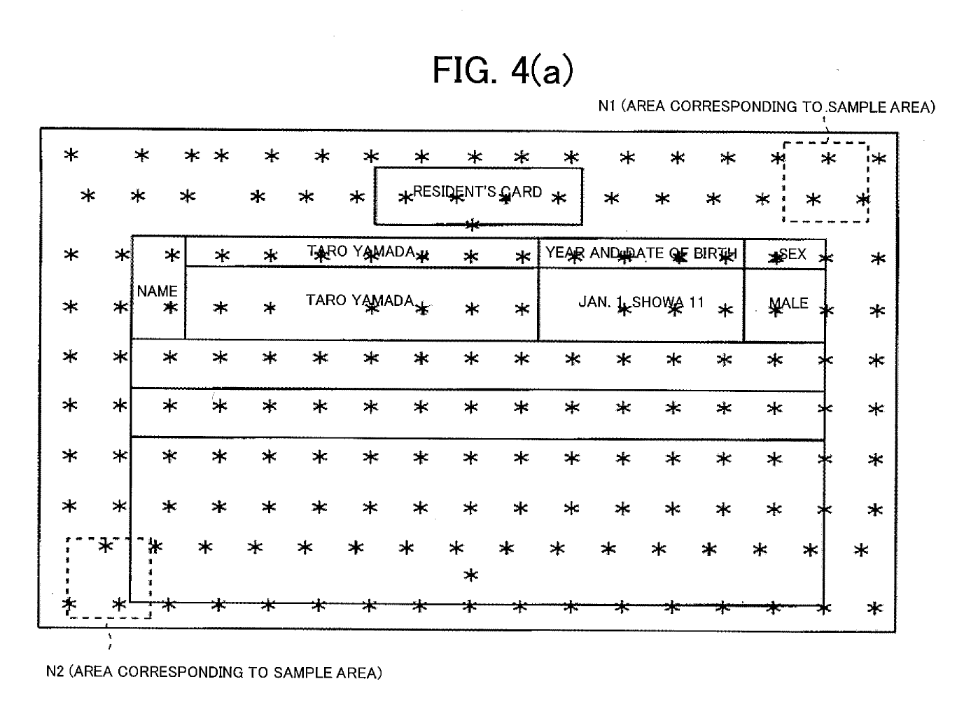

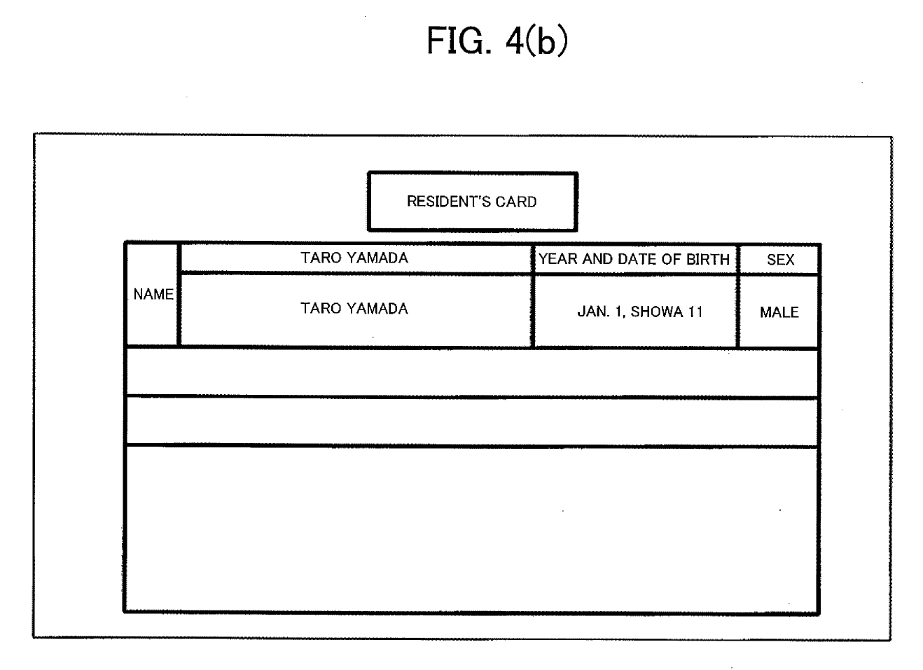

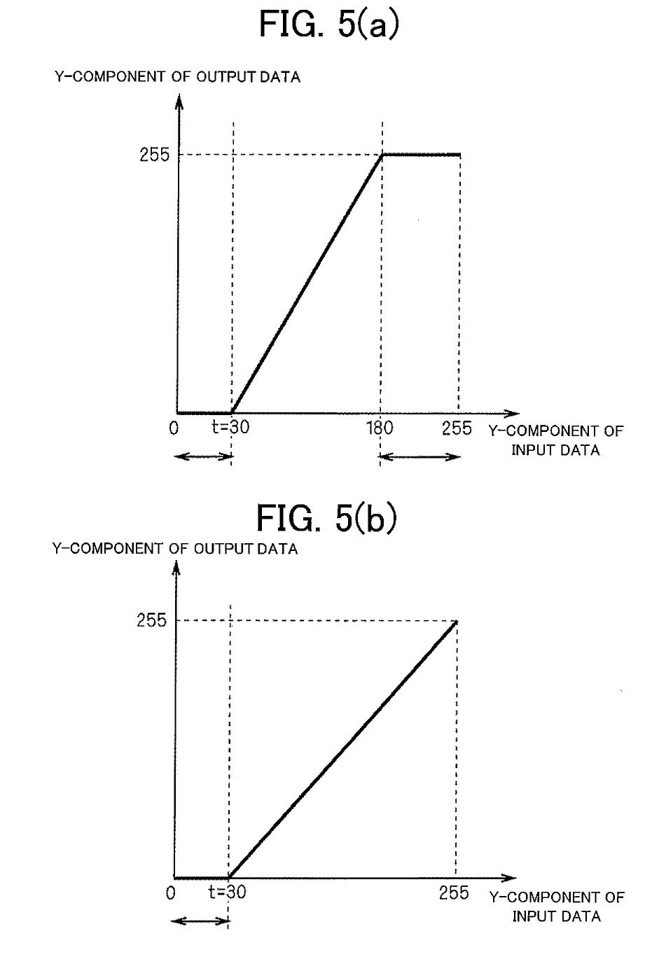

Referring now to FIG. 2, a functional configuration relating to a process to be applied to the special original document will be described. In the description given below, FIGS. 3-5 are referred to as needed. FIG. 3 is a drawing illustrating a fixed-format document to be registered as the special document. FIGS. 4A and 4B are drawings illustrating an example of the special original document and a copy thereof. FIGS. 5A and 5B are examples of conversion graphs relating to Y-component correction.

The digital multifunction peripheral 1 has a configuration relating to the process to be applied to the special document including a special document identification information acquiring unit 101, a color to be skipped information acquiring unit 102, an original document determining unit 103 and a special original document processing unit 104. These functional units are components realized by the control unit 11 carrying out a program. The RAM 13 includes special document information F1, F2, F3, . . . for one or more special documents stored therein. In the following description, a given one of the one or more special document information F1, F2, F3, . . . stored in the RAM 13 is referred to simply as “special document information F”.

The special document information F stores special document identification information D and color-to-be-skipped information C. However, for the special documents which need not to be applied with the “color skipping” process, only the special document identification information D is stored as the special document information F.

The special document identification information D identifies whether an original document is a special document or not. The special document identification information D includes sample area information d1 and document color distribution information d2.

The sample area information d1 specifies a “sample area S” in the special document. For example, when the sample area S is a square area, the coordinate position (for example, the coordinate position of a starting point in a coordinate system having an original point at the lower left of the special document) of the starting point of the sample area S (for example, the lower left apex of the sample area S) and the size of the area are retained as sample area information d1. The sample area S is preferably specified not to include a variable area (an area where the contents described thereon differ from document to document) on a fixed-format document (see FIG. 3). A plurality of areas in a fixed-format document may be specified as the sample area S.

The document color distribution information d2 is relates to the sample area S of the special document. More specifically, it is information that specifies how the pixel data group that constitutes the sample area S on the special document is distributed on a CbCr plane in a YCbCr color space. For example, the distribution of the pixel data is specified by the number of pixel data included respectively in a plurality of color areas on the CbCr plane (for example, sixteen color areas specified by dividing the CbCr plane radially into equal fifteen areas).

The color-to-be-skipped information C specifies the color that is not to be reproduced in a copy (hereinafter, referred to as “color-to-be-skipped”). More specifically, it specifies the distribution area (color skipping area) in the YCbCr color space of the color-to-be-skipped. The maximum value of a Y-area of the color skipping area is fixed to “255” (provided that the Y-components of the pixel data in this embodiment are expressed in 256 tones from 0-255). The color-to-be-skipped area may be specified one-dimensionally by the Y-area, and may be specified three-dimensionally by the Y-area, Cb area and Cr area. When it is specified three-dimensionally, the color-to-be-skipped is located in a more limited manner.

The special document identification information acquiring unit 101 acquires the special document identification information D of a fixed-format document that the user wants to register as a special document (hereinafter, referred to as a “document to be registered K”). The special document identification information acquiring unit 101 includes a sample area specification accepting unit 1011 and a document color distribution information acquiring unit 1012.

The sample area specification accepting unit 1011 acquires the sample area information d1 of the document to be registered K. For example, the sample area specification accepting unit 1011 causes the user to enter a coordinate value of the starting point of an area to be specified as the sample area S and a value of the size of the area to be specified as the sample area S and acquires the entered numerical values as the sample area information d1.

The document color distribution information acquiring unit 1012 acquires the document color distribution information d2 of the document to be registered K. For example, the document color distribution information acquiring unit 1012 extracts the pixel data groups that constitute the sample area S from the image data acquired by scanning the fixed-format document to be registered, and counts the numbers of pixel data groups included in the sixteen color areas specified by radially dividing the CbCr plane into fifteen equal areas. Then, the counted numbers are acquired as the document color distribution information d2 of the special document.

The color-to-be-skipped information acquiring unit 102 acquires the color-to-be-skipped information C of the document to be registered K. The color to be skipped information acquiring unit 102 includes a color skipping area specification accepting unit 1021 and a color component information acquiring unit 1022.

The color skipping area specification accepting unit 1021 accepts the specification of the color-to-be-skipped from the user. More specifically, the color skipping area specification accepting unit 1021 accepts the specification of an area where the color-to-be-skipped appears on the document to be registered K (color skipping area T) from the user. For example, the color skipping area specification accepting unit 1021 causes the user to enter a coordinate value of the starting point of an area to be specified as the color skipping area T and a value of the size of the area to be specified as the color skipping area T, and acquires the entered numerical values as information to locate the color skipping area T. A plurality of areas on a fixed-format document may be specified as a color skipping area T. The color skipping area T may be an area corresponding to the sample area S described above.

The color component information acquiring unit 1022 acquires the color-to-be-skipped information C of the document to be registered K. For example, the color component information acquiring unit 1022 extracts the pixel data groups which constitute the color skipping area T from the image data acquired by scanning the document to be registered K, and locates the distribution area of the pixel data groups in the YCbCr color space. Then, the color component information acquiring unit 1022 specifies the distribution area as the color skipping area and acquires information for locating the color skipping area as the color-to-be-skipped information C. However, since the maximum value of the Y-area of the color skipping area is fixed to 255, as described above, when the Y-components of the pixel data groups included in the color skipping area T are distributed from 190-200, for example, the color skipping area is considered as from 190-255. The color skipping area may be specified by adding a predetermined margin. In other words, when the Y-components of the pixel data groups included in the color skipping area T are distributed from 190-200, for example, a margin area 10 may be added to consider the color skipping area as from 180-255.

In particular, when the document to be registered K is added with a tint block (see FIG. 3), the user is able to specify an area added with a faint colored tint block (background image) as the color skipping area T. In this case, the color component information acquiring unit 1022 acquires information that specifies the color area of the tint block on the fixed-format document to be registered as the color-to-be-skipped information C.

The original document determining unit 103 determines whether an original document to be processed is the special original document or not. The original document determining unit 103 includes a document color distribution information acquiring unit 1031 and a color distribution comparing unit 1032.

The document color distribution information acquiring unit 1031 acquires the color distribution information relating to the specified area of the original document. The specified area corresponds to the sample area S of the special document to be determined (that is, the area that is specified by the sample area information d1 retained as the special document information F of the special document to be determined) (see FIG. 4A). For example, the document color distribution information acquiring unit 1031 extracts the pixel data groups that constitute the predetermined area from the image data acquired by pre-scanning the document having a tint block in a faint color, and counts the numbers of pixel data groups included in the sixteen color area specified by radially dividing the CbCr plane into fifteen equal areas. Then, the counted numbers are acquired as color distribution information of the original document (hereinafter, referred to as “original document color distribution information”).

The color distribution comparing unit 1032 compares the document color distribution information d2 retained as the special document information F of the special document to be determined with the original document color distribution information acquired by the original document color distribution information acquiring unit 1031 and determines whether they match or not. When they match, the original document is determined to be a special original document. However, the document color distribution information d2 does not necessarily have to exactly match the original document color distribution information, and may be determined to match when it matches within a predetermined allowable range.

The special original document processing unit 104 carries out a predetermined “special original document image processing” for image data acquired by scanning the special original document (that is, image data obtained by converting multi-tone RGB image data acquired by scanning the special original document by the image scanning unit 16 into multi-tone YCbCr image data (that is, color image data expressed in the YCbCr color space) by the image processing unit 17, and referred to as “special image data” hereinafter). The special original document image processing includes various kinds of image processing such as monochrome conversion, space filtering and Y-component correction (that is, color skipping and black correction). Space filtering is edge emphasis and smoothing, and is a process to improve reproduction of fine lines and restraining noise. The special original document processing unit 104 mainly includes a monochrome converting unit 1041, a color skipping unit 1042 and a black correction unit 1043.

The monochrome converting unit 1041 converts the special image data into monochrome image data (monochrome conversion). More specifically, the monochrome converting unit 1041 discards color information in the special image data and binarizes the luminance component using a simple binarizing method or the like. Then, the luminance component of the obtained YCbCr image data is compressed by the MMR method or the like to obtain the monochrome image data.

The color skipping unit 1042 converts the pixel data of the color-to-be-skipped in the pixel data included in the special image data (that is, pixel data included in the color skipping area whose color components are specified by the color-to-be-skipped information C) into white (color-not-to-be-recorded) pixel data (color skipping). The term “white” in this specification represents a color specified by the maximum value that can be obtained as a “brightness component”. The term “brightness component” corresponds to the component of “luminance” as the brightness on the basis of the luminous quantity (for example, Y-components in the YCbCr color specification system) or the component of “brightness” which is the brightness on the basis of the chromaticness (for example, L component in a L*a*b* color specification system). For example, when color components of the image data are expressed in the YCbCr color space and the values that can be taken as the Y-components are from 0-255, the “white” is a color specified by a Y-component of 255. In other words, the color skipping unit 1042 in this case converts the value of the Y-component of the pixel data of the color-to-be-skipped into a value of 255.

For example, when the color-to-be-skipped area is specified as Y-components from 180-255 in the color-to-be-skipped information C, the color skipping unit 1042 converts the value of the Y-component of the input data whose Y-component is included in a range from 180-255 into 255 and outputs the same (see FIG. 5A). When this conversion is executed, the pixel data in the color-to-be-skipped is converted into white, and hence the portion of the color-to-be-skipped included in the special original document is not reproduced in the copy.

In particular, when the color area of a tint block is retained as the color-to-be-skipped information C, the pixel data of the color-to-be-skipped (that is, the pixel data in the tint block area) is converted into white, and hence the portion of the tint block area included in the special original document is not reproduced in the copy. In other words, the tint block is not stood out in the copy (see FIG. 4B).

The black correction unit 1043 converts the pixel data whose value of the Y-component is equal to or smaller than a predetermined value t (a preset arbitrary value, for example, t=30) in the image data included in the special image data into black pixel data (black correction). The term “black” in this specification indicates a color specified by a minimum value which can be taken as “brightness component”. For example, when the color component of the image data is expressed in the YCbCr color space and the value which can be taken as the Y-component is in a range from 0-255, “black” is a color specified by a Y-component of 0. In other words, the black correction unit 1043 in this case converts the value in the Y-component in the pixel data equal to or smaller than the predetermined value t into 0.

For example, when the predetermined value t is set to 30, the black correction unit 1043 converts the value of the Y-component of the input data whose Y-component is equal to or smaller than 30 into 0 and outputs the same (see FIG. 5A). When this conversion process is carried out, the pixel data whose Y-component is equal to or smaller than the predetermined value t is converted into black, and hence the black area reproduced on a medium is increased. In other words, black is emphasized in the copy of the special original document.

The special original document processing unit 104 converts the Y-component of the pixel data that is neither the target of the color skipping nor the target of the black correction (that is, pixel data whose color component is not included in the color skipping area specified by the color-to-be-skipped information C and whose Y-component is larger than the predetermined value t) linearly so that the output range falls within a range from 0-255 (see FIG. 5A). In other words, the special original document processing unit 104 sets a conversion formula so as not to generate a non-sequential portion of the Y-component in the output data, and carries out a conversion process of the Y-component.

### 2. Processing Operation

The image forming process carried out by the digital multifunction peripheral 1 is now described. It is assumed that special document information F1, F2, F3, . . . relating to the one or more special documents respectively are stored in the RAM 13 as a condition of execution of the image forming process. The special document information F may already be registered as retained information of the digital multifunction peripheral 1 at the time of shipping or may be registered newly by the user. For example, when the special document is of a format that does not depend on regions such as a motor vehicle inspection certificate, the special document information F relating to the special document in question may already be registered as retained information of the digital multifunction peripheral 1 at the time of shipping. When the special document has different formats depending on regions, such as resident's cards, the special document information F relating to the special document in question may be registered newly by the user.

### 2-1. Registration Acceptance of Special Document Information F

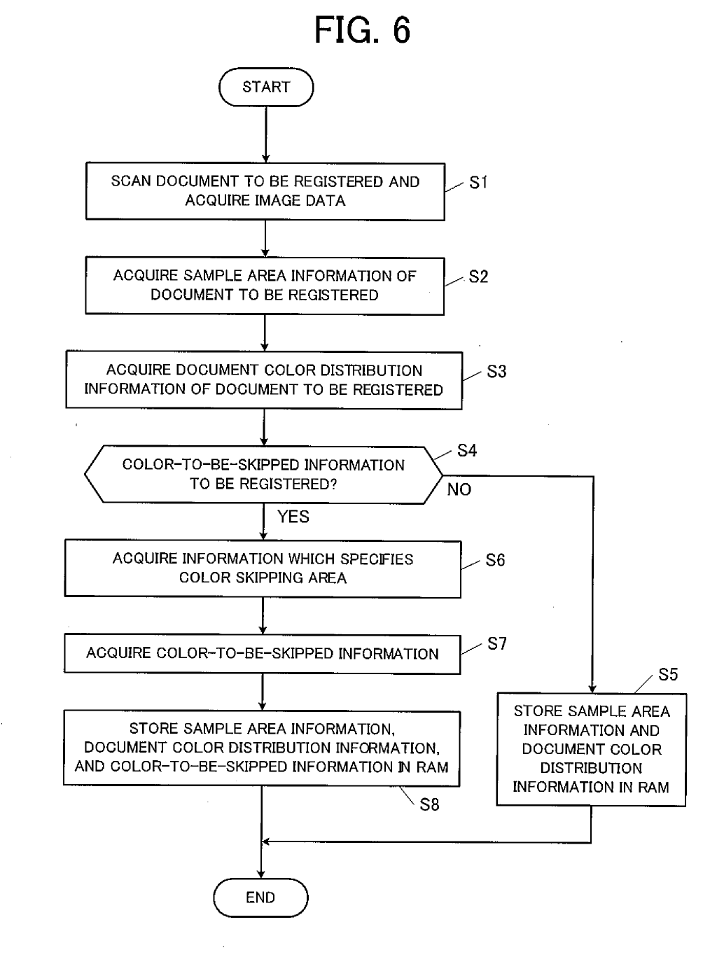

Referring now to FIG. 6, a process operation carried out when accepting registration of the special document information F newly by the user is described.

When the user sets a fixed-format document (document to be registered K) to be registered as a special document on an original document table (or glass table) and inputs an instruction to start registration of the special document from a menu screen, for example, the registration acceptance of the special document information F is started.

First, the image scanning unit 16 scans the document to be registered K and acquires image data (Step S1).

The sample area specification accepting unit 1011 then acquires the sample area information d1 of the document to be registered K (Step S2). More specifically, the sample area specification accepting unit 1011 displays a predetermined message (for example, “Please specify an area for acquiring sample information”) on the display unit 15 and prompts the user to enter a coordinate value of the starting point of the area to be specified as the sample area S and a value of the area size to be specified as the sample area S. When the user enters a desired numerical value in response to the message, the entered numerical value is acquired as the sample area information d1 (see FIG. 3).

The document color distribution information acquiring unit 1012 then acquires the document color distribution information d2 of the document to be registered K (Step S3). More specifically, the document color distribution information acquiring unit 1012 extracts image data groups that constitute the sample area S (that is, the area located by the sample area information d1 acquired in Step S2) from the image data acquired in Step S1, and counts the number of pixel data groups included in sixteen color areas specified by radially dividing the CbCr plane into fifteen equal areas. Then, the counted numbers are acquired as the document color distribution information d2 of the special document.

Then, the color skipping area specification accepting unit 1021 asks the user whether or not the color-to-be-skipped information C should be registered (Step S4). For example, the color skipping area specification accepting unit 1021 displays a predetermined message such as “Do you want to register a color to be skipped?” on the display unit 15.

When the user indicates that the color-to-be-skipped information C should not be registered, the special document identification information acquiring unit 101 stores the sample area information d1 acquired in Step S2 and the document color distribution information d2 acquired in Step S3 in the RAM 13 as a new special document information F (Step S5).

When the user indicates in Step S4 that the color-to-be-skipped information C should be registered, the color skipping area specification accepting unit 1021 then acquires information that locates the color skipping area T of the document to be registered K (Step S6). For example, the color skipping area specification accepting unit 1021 displays a predetermined message such as “Please specify an area where the color to be skipped appears” on the display unit 15, and prompts the user to enter the coordinate value of the starting point of the area to be specified as the color skipping area T and a value of the area size to be specified as the color skipping area T. The entered numerical value is acquired as information that specifies the color skipping area T.

Next, the color component information acquiring unit 1022 acquires the color-to-be-skipped information C of the document to be registered K (Step S7). More specifically, the color component information acquiring unit 1022 extracts pixel data groups that constitute the color skipping area T (that is, the color skipping area T located by the information acquired in Step S6) from the image data acquired in Step S1, and locates the distribution area in the YCbCr color space of the pixel data groups. Then, the color component information acquiring unit 1022 determines the distribution area as the color skipping area and acquires information that locates the color skipping area as the color-to-be-skipped information C.

In Step S8, the special document identification information acquiring unit 101 stores the sample area information d1 acquired in Step S2 and the document color distribution information d2 acquired in Step S3 in the RAM 13, and the color-to-be-skipped information acquiring unit 102 stores the color-to-be-skipped information C acquired in Step S7 in the RAM 13. In other words, the sample area information d1, the document color distribution information d2 and the color-to-be-skipped information C are stored in the RAM 13 as new special document information F. The process of accepting the registration of the special document information F from the user is then ended.

### 2-2. Image Forming Process

The image forming process to be carried out in the digital multifunction peripheral 1 is now described.

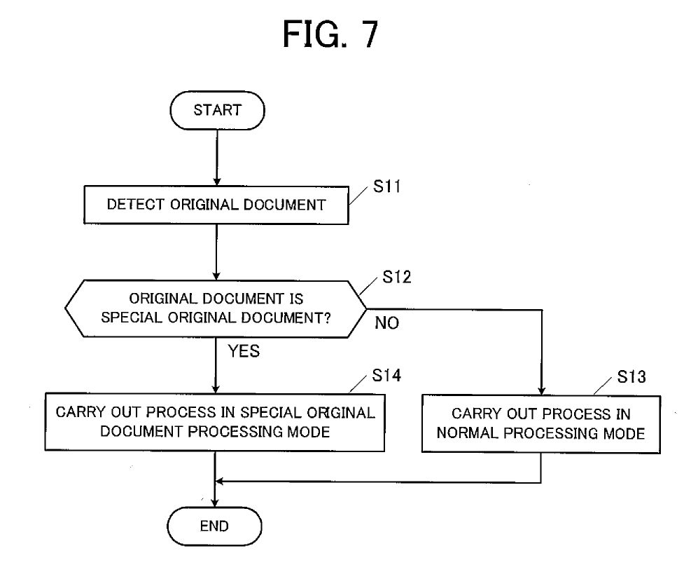

Referring now to FIG. 7, a rough flow of the image forming process carried out in the digital multifunction peripheral 1 is described.

When the fact that an original document is set on the document table (or the glass table) is detected and a user entry indicating that copying of the original document is to be started (Step S11) is accepted, the image forming process of the document is started. First, the original document determining unit 103 determines whether the document set by the user is a special document or not (Step S12). When the original document is not a special original document, the process for the original document in question is carried out in the normal processing mode (Step S13). On the other hand, when the original document is a special original document, the process is carried out for the original document in question in the special original document processing mode (Step S14). The processes in Steps S12 and S14 are described in detail below.

### 2-2-1. Determination of Whether the Document is a Special Original Document

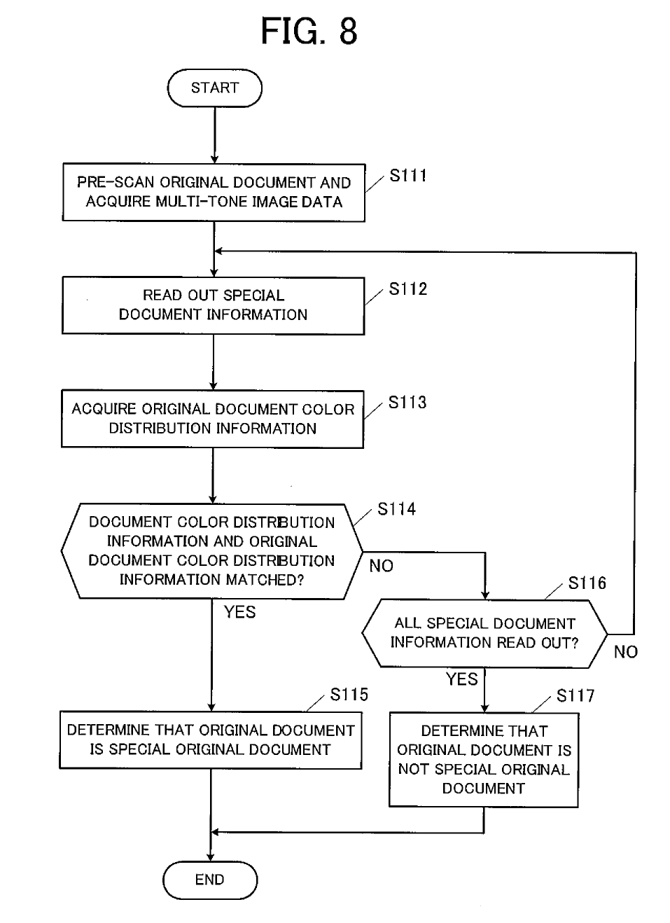

Referring to FIG. 8, the determination of whether the original document is a special original document or not (the process in Step S12 in FIG. 7) is described.

First, the original document is pre-scanned (that is, image data to be used for various determinations is acquired by scanning the original document roughly before scanning the original document for acquiring the image data) to acquire multi-tone image data (Step S111).

In Step S112, one of the plurality of special document information F1, F2, F3, . . . stored in the RAM 13 is read.

Then, in Step S113, the original document color distribution information acquiring unit 1031 acquires color distribution information (original document color distribution information) relating to an area corresponding to the sample area S on the original document (that is, an area corresponding to an area specified by the sample area information d1 retained as the special document information F scanned in Step S112). More specifically, the document color distribution information acquiring unit 1031 extracts pixel data groups that constitute the area corresponding to the sample area S from the image data acquired in Step S111 and counts the number of pixel data groups included in the sixteen color areas specified by radially dividing the CbCr plane into fifteen equal areas. Then, the counted numbers are acquired as the original document color distribution information. Two areas on the original document may be specified as the area corresponding to the one sample area S. In this case, the first area is an area N1 specified directly by the sample area information d1 and the second area is an area N2 which is in a point symmetry relation with respect to the area N1 about the center of the original document (see FIG. 4A). The second area N2 is a position where the first area N1 appears when the original document is placed upside down. When the two areas N1 and N2 are specified as areas corresponding to the area specified by the sample area information d1, the original document color distribution information acquiring unit 1031 acquires the color distribution information of the two areas N1 and N2 as the original document color distribution information.

Next, in Step S114, the color distribution comparing unit 1032 compares the document color distribution information d2 retained as the special document information F scanned in Step S112 with the original document color distribution information acquired in Step S113 and determines whether they match or not. When the color distribution information individually for the two areas N1 and N2 are acquired as the original document color distribution information in Step S113, the color distribution comparing unit 1032 determines whether or not the document color distribution information d2 matches at least one of the color distribution information about the first area N1 and the color distribution information about the second area N2.

When the document color distribution information d2 matches the original document color distribution information in Step S114, it is determined that the original document is the special original document (Step S115). When the color distribution information of the two areas N1 and N2 are acquired respectively as the original document color distribution information, it is determined that the original document is the special original document when one of them matches the document color distribution information d2. Therefore, in this case, there is no probability that the special original document might be erroneously determined as the normal document because the original document is placed upside down.

In contrast, when the document color distribution information d2 matches the original document color distribution information in Step S114, it is determined in Step S116 whether all the special document information F1, F2, F3, . . . stored in the RAM 13 are read out or not.

When it is determined that all the special document information F1, F2, F3, . . . stored in RAM 13 are not read out in Step S116, the procedure goes back again to the process in Step S112.

In contrast, when it is determined that all the special document information F1, F2, F3, . . . stored in the RAM 13 are read out in Step S116 (i.e., when the original document matches none of registered special documents), it is determined that the original document is not the special original document (Step S117). The process described thus far is a determination of whether the original document is the special original document or not.

### 2-2-2. Process to be Applied to Special Original Document

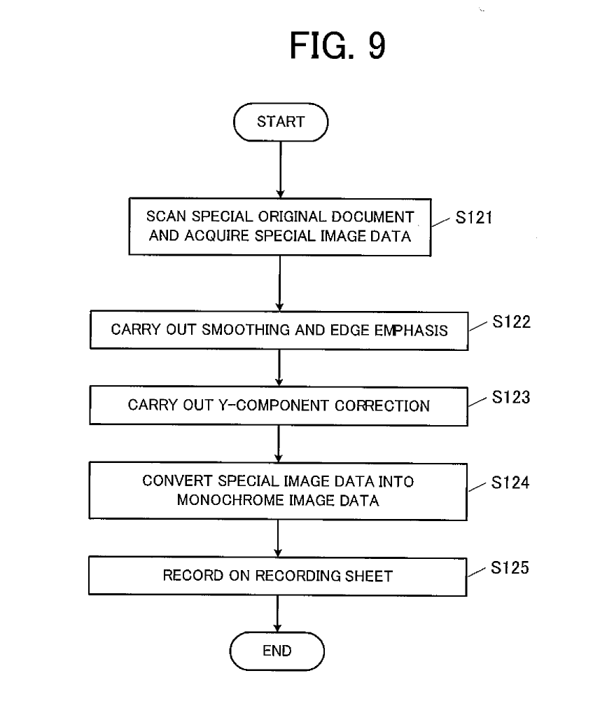

Referring to FIG. 9, the process to be applied to a special original document (the process in Step S14 in FIG. 7) is described (that is, a process to be carried out in the special original document processing mode).

First, the special original document is scanned in Step S121 to acquire special image data. More specifically, the image scanning unit 16 scans the special original document to acquire multi-tone RGB image data, and then the image processing unit 17 converts the acquired RGB image data into multi-tone YCbCr image data to acquire the special image data.

In Step S122, the special original document processing unit 104 carries out space filtering (smoothing and edge emphasizing) for the image data acquired in Step S121.

Next, in Step S123, the special original document processing unit 104 carries out a predetermined Y-component correction for the processed image data in Step S122.

For example, when the special original document to be processed corresponds to the document whose color-to-be-skipped information C is retained as the special document information F, the Y-component is corrected on the basis of the conversion graph in FIG. 5A. In other words, the color skipping unit 1042 converts the value of the Y-component of pixel data of the color-to-be-skipped from among the pixel data included in the special image data (that is, the pixel data included in the color skipping area whose color component is specified by the color-to-be-skipped information C (in the example in FIG. 5A, an area whose Y-component is in a range from 180-255)) into a value 255 (color skipping process). The black correction unit 1043 converts the value of the Y-component of the pixel data that is equal to or smaller than the predetermined value t (t=30 in the example in FIG. 5A) from among the pixel data included in the special image data into 0 (black correction).

For example, when the special original document to be processed corresponds to the document whose color-to-be-skipped information C is not retained as the special document information F, the Y-component is corrected on the basis of the conversion graph illustrated in FIG. 5B. In other words, the black correction unit 1043 converts the value of the Y-component of the pixel data that is equal to or lower than the predetermined value t (t=30 in the example shown in FIG. 5A) from among the pixel data included in the special image data into 0 (black correction).

The monochrome converting unit 1041 then converts the image data after the process in Step S123 into monochrome image data (Step S124). More specifically, the monochrome converting unit 1041 discards the color information of the image data, binarizes the luminance component using a simple binarizing method or the like, and compresses the luminance component in the MMR format or the like, so that monochrome image data is acquired.

Next, the image recording unit 18 records the monochrome image data on a recording sheet (Step S125). Accordingly, a copy of the special original document is obtained (see FIG. 4B). The process to be applied to the special original document is as described thus far.

### 3. Advantages

According to the embodiment described above, whether or not an original document is a special original document is determined, and when it is the special original document, the process is carried out in a predetermined special original document processing mode. In the special original document processing mode, image data acquired by scanning an original document by the monochrome converting unit 1041 is converted into a monochrome document. Therefore, copies in which character information is clearly readable are obtained.

Since the special document identification information acquiring unit 101 accepts registration of the special document identification information D from the user, the user is able to register a desired document as the special document.

Since the sample area specification accepting unit 1011 accepts registration of the sample area information d1 from the user, the user is able to determine a desired area of the document to be registered as the special document as the sample area S.

In the case of a special original document, since the color skipping unit 1042 converts the pixel data of the color-to-be-skipped included in the image data acquired by scanning the special original document into white pixel data, the portion of the color-to-be-skipped included in the special original document is not reproduced on the copy. Accordingly, the character information in the copies is stood out.

Since the color to be skipped information acquiring unit 102 acquires the color-to-be-skipped information C that specifies the color-to-be-skipped to be converted into the white component on the basis of the instruction from the user, the user is able to specify a given color on the document to be registered as the special document as the color-to-be-skipped.

In particular, when the color-to-be-skipped is determined as the color of the tint block of the special document, the tint block is not reproduced in the copy. In other words, the tint block is not stood out in the copy. Therefore, even when the tint block is added to the original document, copies in which character information is clearly readable are obtained (see FIG. 4B).

In the case of the special original document, since the black correction unit 1043 converts pixel data whose value of Y-component is equal to or smaller than the predetermined value into black pixel data, the black area reproduced on the medium is increased. In other words, black color is emphasized on the copy. Accordingly, the character information in the copies is clearly stood out.

### 4. Modification

### 4-1. First Modification

In the embodiment described above, the color skipping area specification accepting unit 1021 accepts the specification of the color skipping area T from the user and the color component information acquiring unit 1022 acquires information that locates the distribution area (color skipping area) of the pixel data groups that constitute the color skipping area T in the image data acquired by scanning the document to be registered K in the YCbCr color space as the color-to-be-skipped information C. However, a configuration in which the information that specifies the color skipping area T is retained as the color-to-be-skipped information C is also applicable.

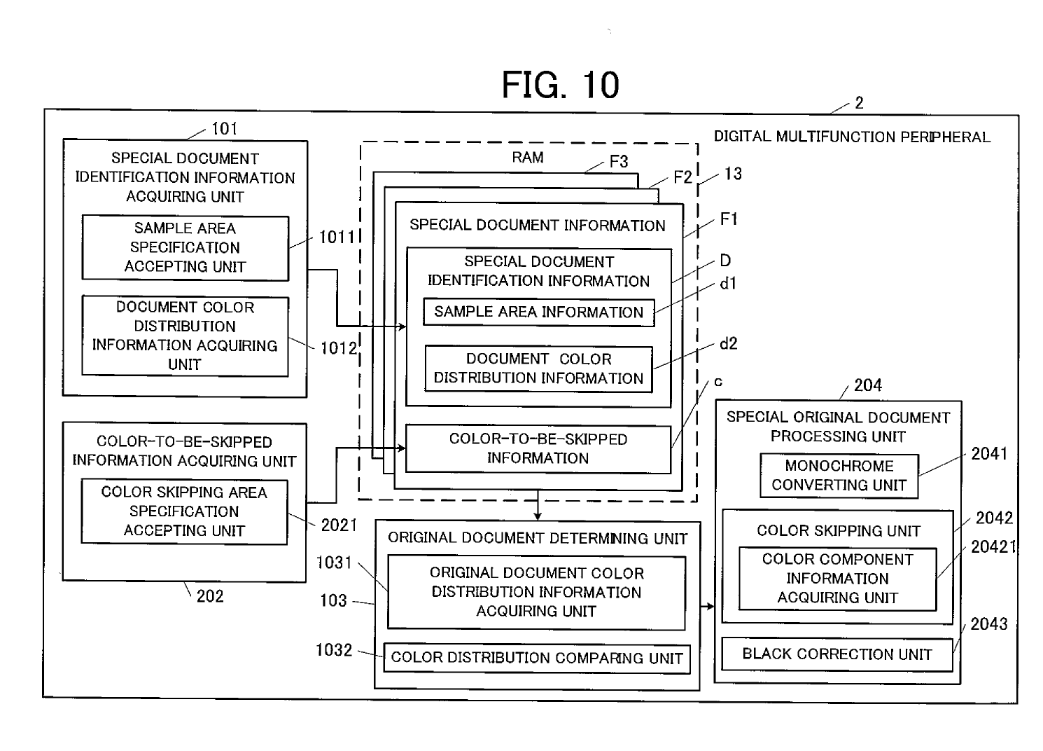

Referring now to FIG. 10, a functional configuration relating to the process to be applied to a special original document of a digital multifunction peripheral 2 according to a modified embodiment is described. In FIG. 10, the same functional components as those in FIG. 2 are represented by the same reference numerals and repeat description of their functions is omitted.

In the digital multifunction peripheral 2, the special document information F1, F2, F3, . . . relating to at least one special document are stored in the RAM 13 in the same manner as the digital multifunction peripheral 1, and each special document information F includes special document identification information D and color-to-be-skipped information C. The color-to-be-skipped information C specifies the color skipping area T on the special document.

The digital multifunction peripheral 2 includes the special document identification information acquiring unit 101, a color-to-be-skipped information acquiring unit 202, the original document determining unit 103 and a special original document processing unit 204.

The color-to-be-skipped information acquiring unit 202 acquires the color-to-be-skipped information C of the document to be registered K. The color-to-be-skipped information acquiring unit 202 includes a color skipping area specification accepting unit 2021.

The color skipping area specification accepting unit 2021 accepts the specification of the area on which the color-to-be-skipped appears (color skipping area T) on the document to be registered K from the user. Then, the color skipping area specification accepting unit 2021 acquires the information that specifies the accepted color skipping area T as the color-to-be-skipped information C.

The special original document processing unit 204 carries out special original document image processing on special image data. The special original document processing unit 204 mainly includes a monochrome converting unit 2041, a color skipping unit 2042 and a black correction unit 2043. The monochrome converting unit 2041 and the black correction unit 2043 are the same as the monochrome converting unit 1041 and the black correction unit 1043 described above.

The color skipping unit 2042 includes a color component information acquiring unit 20421. The color component information acquiring unit 20421 locates the color skipping area on the basis of the color-to-be-skipped information C (that is, the information that specifies the color skipping area T) prior to the execution of the color skipping process. More specifically, the color component information acquiring unit 20421 extracts pixel data groups that constitute an area corresponding to the color skipping area T (that is, an area specified by the color-to-be-skipped information C retained as the special document information F of the special document relating to the original document in question) from the special image data, which is a target of the color-skipping process, and specifies the distribution area of the pixel data groups in the YCbCr color space. Then, the distribution area is determined as the color skipping area. The maximum value of the Y-area of the color skipping area is fixed to 255 as in the embodiment described above.

The color skipping unit 2042 converts pixel data in the color-to-be-skipped from among the pixel data included in the special image data (that is, the pixel data included in the color skipping area specified by the color component information acquiring unit 20421) into pixel data in white.

In other words, in the first embodiment, the color distribution area of the pixel data groups that constitute the color skipping area T in the image data acquired by scanning the document to be registered K is specified as the color skipping area. However, in this modified embodiment, the color distribution area of the pixel data groups that constitute the color skipping area T in the image data acquired by scanning the original document that is determined to be a special original document (that is, the special image data as a target of the color skipping process) is determined as the color skipping area.

In general, even among special original documents of the same kind, the density or the hue may vary among individual documents, and the area of the color-to-be-skipped (for example, the area of the color of the tint block) is not always exactly the same. Therefore, when the color skipping process is uniformly carried out on the basis of the color skipping area registered in advance, as described above, such variations in density or the like among the original documents cannot be taken into consideration. Therefore, there is a possibility that the tint block or the like on the original document cannot be skipped accurately. However, according to the configuration in this modification, the color skipping process of the original document is carried out according to the color skipping area specified on the basis of the image data of the each original document, so that the tint block or the like on the original document is skipped accurately even though there are variations in density or the like among the original documents.

### 4-2. Second Modification

In the embodiment described above, the sample area information d1 and the document color distribution information d2 are retained as the special document identification information D. However, information that specifies the size of the special document (document size information) may be additionally retained as the special document identification information D. In this case, for example, when the fixed-format document to be registered as the special document is A4 size, the A4 size (297 mm×210 mm) is retained as the document size information.

The special document identification information acquiring unit 101 according to the modification acquires the document size information in addition to the sample area information d1 and the document color distribution information d2 as the special document identification information D of the document to be registered K. For example, the special document identification information acquiring unit 101 detects the sheet size of the document to be registered K and acquires the detected sheet size as the document size information.

In other words, in the special document information F registration accepting process carried out in the digital multifunction peripheral 1 according to this modification, when the image scanning unit 16 scans the document to be registered K to acquire the image data (Step S1 in FIG. 6), the special document identification information acquiring unit 101 detects the sheet size of the document to be registered K and acquires the detected sheet size information as the document size information. The process steps from then onward are the same as the embodiment described above (see Step S2 to Step S8 in FIG. 6).

When determining whether or not the original document to be processed is a special original document, the original document determining unit 103 according to this modification detects the original document size, then compares the detected original document size with the document size information retained as the special document identification information D of the special document to be determined, and then determines whether they match. When they do not match, the original document is determined not to be the special original document, and when they match, the original document is determined to have a possibility to be the special original document.

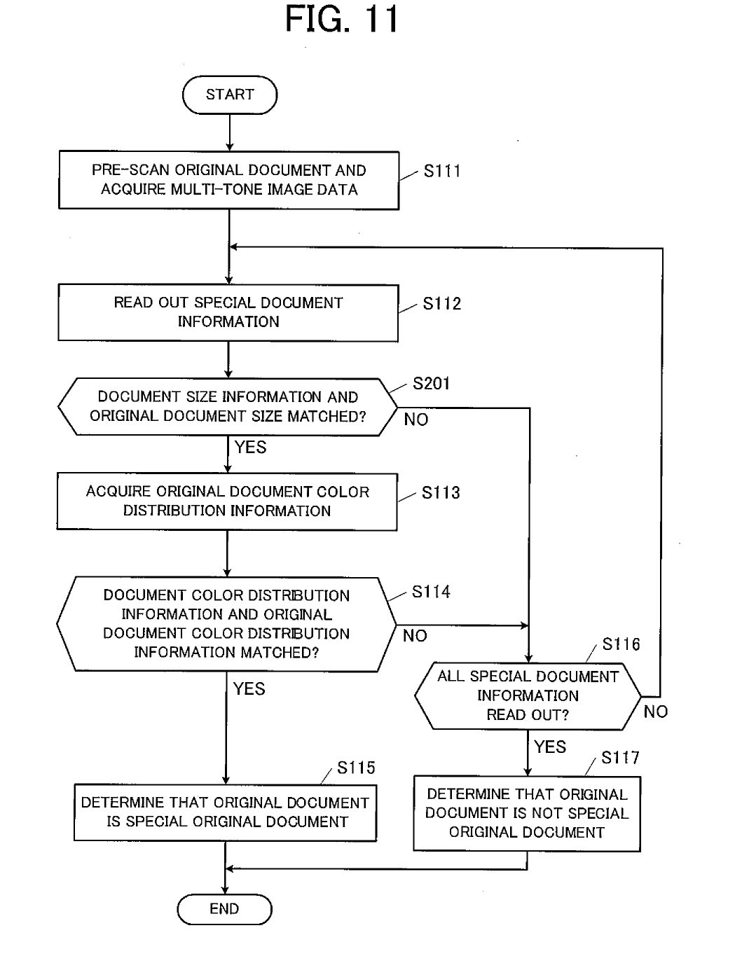

Referring now to FIG. 11, a process of determining whether or not the original document is a special original document (the process in Step S12 in FIG. 7) carried out in the digital multifunction peripheral 1 according to the modification is described. In FIG. 11, the same steps as in FIG. 8 are represented by the same reference numerals, and repeat description of these steps is omitted.

First, the original document is pre-scanned to acquire multi-tone image data (Step S111), and then one of the plurality of special document information F1, F2, F3, . . . stored in the RAM 13 is read out (Step S112).

The original document determining unit 103 then compares document size information retained as the special document information F read out in Step S112 with the original document size pre-scanned in Step S111 and determines whether or not they match (Step S201).

When the document size information and the original document size match in Step S201, it is determined that the original document has a possibility to be the special original document, and the procedure goes to Step S113. The process steps from Step S113 onward are the same as in the embodiment described above.

On the other hand, when the document size information does not match the original document size in Step S203, it is determined that the original document is not the special original document and the procedure goes to Step S116 without carrying out the process in Steps S113 and S114. The process steps from Step S116 onward are the same as those in the embodiment described above.

According to the digital multifunction peripheral 1 in this modification, whether or not an original document is a special original document is determined first using document size information, and hence the fact that the original document is not a special original document is determined without acquiring the color distribution information of the original document when the size of the original document is different from the size of the special document. Therefore, the speed of the determination process is increased.

### 4-3. Third Modification

In the embodiment described above, the user is able to specify a given area in the document to be registered K as the color skipping area T by the provision of a configuration that accepts specification of the color-to-be-skipped from the user (the color skipping area specification accepting unit 1021). In general, the color of the tint block has a high luminance so as not to impair the character information or the like in many cases. In the embodiment described above, it is assumed that such a high luminance area is specified as the color-to-be-skipped. Therefore, when the minimum value of the Y-area of the skipping color area is an unexpectedly small value, most colors in the image data are converted into white, and an adequate copy may not be obtained. Therefore, a caution that an adequate copy may not be generated may be given to the user when the minimum value of the Y-area of the color skipping area is unexpectedly small.

For example, an additional configuration may be provided that locates the distribution area of the pixel data groups that constitute the color skipping area T (that is, the color skipping area T specified by the user and accepted by the color skipping area specification accepting unit 1021) in the YCbCr color space, determines whether or not the minimum value of the Y-area is smaller (that is, darker) than the predetermined value and, when it is smaller than the predetermined value, causes the display unit 15 to display a predetermined caution message (for example, messages such as “The specified color is too dark to convert into white” or “The specified color is too dark. Do you want to convert the portion brighter than the specified color into white?”).

### 4-4. Other Modification

In the embodiments shown above, whether or not the original document is a special original document is determined using multi-tone image data acquired by pre-scanning (see Step S111 in FIG. 7). However, the pre-scanning does not necessarily have to be carried out. For example, the determination may be carried out using multi-tone YCbCr image data acquired as data to be used for forming an image and stored in the memory.

In the embodiments described above, the color-not-to-be-recorded is assumed to be white. This is based on the condition that the recording sheet is white. However, if color of the recording sheet is not white, the color-not-to-be-recorded does not necessarily have to be white.

In the embodiments described above, image data specified in the YCbCr color space has been described. However, the invention is also applicable to image data of various other color specification systems (for example, L*a*b*, YIQ and Luv color specification systems) in which the brightness component and the color components are separated.

The sequence of the process to be applied to a special original document described above may be changed as needed. For example, it may be carried out in the order of smoothing, color skipping, edge emphasis and black correction. Moreover, all these processes do not necessarily have to be carried out.

In the embodiments described above, the individual components realized by the control unit 11 carrying out the program may be realized by a circuit (hardware).

While the present invention has been described with respect to embodiments thereof, it will be apparent to those skilled in the art that the invention may be modified in numerous ways and may assume many embodiments other than those specifically set out and described above. Accordingly, the appended claims cover all modifications that fall within the true spirit and scope of the present invention.

What is claimed is:

1. An image processing apparatus comprising:
a special document identification information storage unit that stores identification information of color image element for identifying a special document, which is a fixed-format document on which character information is written in a predetermined format;
a determining unit that determines whether or not an original document corresponds to the special document on the basis of the identification information;
an image data converting unit that converts image data acquired by scanning the original document into monochrome image data when the original document corresponds to the special document and; and
an output unit that outputs the monochrome image data.

2. The image processing apparatus according to claim 1, wherein the identification information is color distribution information of a predetermined sample area on the fixed-format document.

3. The image processing apparatus according to claim 2, further comprising:
a special document identification information acquiring unit that scans the fixed-format document to be registered as the special document and acquires the color distribution information in the predetermined sample area on the fixed-format document.

4. The image processing apparatus according to claim 3, wherein the special document identification information acquiring unit includes a sample area determining unit that determines the sample area on the fixed-format document according to an instruction from a user.

5. The image processing apparatus according to claim 4, further comprising:
a color skipping unit that converts a predetermined color that is included in the image data acquired by scanning the original document into a color-not-to-be-recorded when the original document corresponds to the special document.

6. The image processing apparatus according to claim 5, wherein the color skipping unit includes a color-to-be-skipped determining unit that determines a color that is to be converted into the color-not-to-be recorded according to an instruction from the user.

7. The image processing apparatus according to claim 6, wherein the color-to-be-skipped determining unit comprises:
a color-to-be-skipped area specification accepting unit that accepts a specification of the color skipping area on the fixed-format document to be registered as the special document from the user; and
a color information acquiring unit that acquires color information of the color skipping area on the fixed-format document by scanning the fixed-format document and determines the acquired color information as color information of a color to be converted into the color-not-to-be-recorded.

8. The image processing apparatus according to claim 6, wherein:
the color-to-be-skipped determining unit comprises a color-to-be-skipped area specification accepting unit that accepts a specification of the color skipping area on the fixed-format document to be registered as the special document from the user; and
the color skipping unit comprises the color information acquiring unit that scans the original document when the original document corresponds to the special document to acquire the color information of the color skipping area on the original document as the color information of the color to be converted into the color-not-to-be-recorded.

9. The image processing apparatus according to claim 5, wherein the predetermined color is the color of a tint block.

10. The image processing apparatus according to claim 9 further comprising:
a black correction unit that converts the predetermined color included in the image data acquired by scanning the original document into black when the original document corresponds to the special document.

11. An image processing method comprising:
determining a fixed-format document on which character information is written in a predetermined format as a special document;
storing identification information of color image element for identifying the special document;
determining whether or not the original document corresponds to the special document on the basis of the identification information;
converting the image data acquired by scanning the original document into monochrome image data when the original document corresponds to the special document; and
outputting the monochrome image data.

12. The image processing method according to claim 11, wherein the identification information is color distribution information of a predetermined sample area on the fixed-format document.

13. The image processing method according to claim 12, further comprising:
scanning the fixed-format document to be registered as the special document and acquiring the color distribution information in the predetermined sample area on the fixed-format document.

14. The image processing method according to claim 13, further comprising:
determining the sample area on the fixed-format document according to an instruction from a user.

15. The image processing method according to claim 14, further comprising:
converting a predetermined color that is included in the image data acquired by scanning the original document into a color-not-to-be-recorded when the original document corresponds to the special document.

16. The image processing method according to claim 15, further comprising:
Determining a color that is to be converted into the color-not-to-be recorded according to an instruction from the user.

17. The image processing method according to claim 16, further comprising:
accepting a specification of the color skipping area on the fixed-format document to be registered as the special document from the user;
acquiring color information of the color skipping area on the fixed-format document by scanning the fixed-format document; and
determining the acquired color information as color information of a color to be converted into the color-not-to-be-recorded.

18. The image processing method according to claim 15, wherein the predetermined color is the color of a tint block.

19. The image processing method according to claim 18, further comprising:
converting the predetermined color included in the image data acquired by scanning the original document into black when the original document corresponds to the special document.

20. A digital multifunction peripheral that implements the image processing method according to claim 11.
